(19) United States
(12) Patent Application Publication
(10) Pub. No.: US 2023/0028858 A1
(43) Pub. Date: Jan. 26, 2023

(54) LOCKING/UNLOCKING SYSTEM, LOCKING/UNLOCKING DEVICE, AND KEY CYLINDER DEVICE

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/865,628

(22) Filed: Jul. 15, 2022

(30) Foreign Application Priority Data
Jul. 21, 2021 (JP) 2021-120462

(51) Int. Cl. E05B 49/00; E05B 81/16; E05B 85/06

(52) U.S. Cl. CPC E05B 49/004; E05B 81/16; E05B 85/06

(57) ABSTRACT

In a key cylinder device, an antenna coil is disposed so as to form a loop around a rotor that is adapted to perform a rotary operation with a mechanical key. A control device is configured to allow locking/unlocking of the reclosable body based on proximity wireless communication performed between the antenna coil and an antenna installed in a mobile device that is adapted to be carried by a user.

### CROSS-REFERENCE TO RELATED APPLICATION

The present application is based on Japanese Patent Application No. 2021-120462 filed on Jul. 21, 2021, the entire contents of which are incorporated herein by reference.

### BACKGROUND

The presently disclosed subject matter relates to a locking/unlocking system and a locking/unlocking device for locking/unlocking a reclosable body using proximity wireless communication. The presently disclosed subject matter also relates to a key cylinder device adapted to be used in the locking/unlocking system and the locking/unlocking device.

Japanese Patent Publication No. 2014-224446A discloses a locking/unlocking system for locking/unlocking a door of a vehicle, which is an example of the reclosable body, using the proximity wireless communication. The locking/unlocking system includes a sheet antenna and a control device. The sheet antenna is disposed on an outer face of the door. The control device allows the door to be locked and unlocked based on the proximity wireless communication performed between the sheet antenna and an antenna installed in a medium capable of being carried by a user.

### SUMMARY

It is demanded to improve the convenience of the locking/unlocking system for locking/unlocking the reclosable body using the proximity wireless communication.

An illustrative aspect of the presently disclosed subject matter provides a locking/unlocking system configured to perform locking/unlocking of a reclosable body, comprising:

a key cylinder device provided with a rotor that is adapted to perform a rotary operation with a mechanical key;

an antenna coil disposed so as to form a loop around the rotor; and

a control device configured to allow the locking/unlocking of the reclosable body based on proximity wireless communication performed between the antenna coil and an antenna installed in a mobile device that is adapted to be carried by a user.

An illustrative aspect of the presently disclosed subject matter provides a locking/unlocking device configured to perform locking/unlocking of a reclosable body, comprising:

an operated member adapted to accept an operation of a user who opens and closes the reclosable body; and

a key cylinder device configured to switch between a locked state and an unlocked state of the reclosable body,

wherein the key cylinder device includes:
a rotor adapted to perform a rotary operation with a mechanical key; and
an antenna coil disposed so as to form a loop around the rotor.

An illustrative aspect of the presently disclosed subject matter provides a key cylinder device, comprising:

a rotor adapted to perform a rotary operation with a mechanical key; and

an antenna coil disposed so as to form a loop around the rotor.

According to the configuration of each illustrative aspect described above, in response to an action of a user bringing an appropriate mobile device close to the key cylinder device, the reclosable body can be locked and unlocked without using a mechanical key. On the other hand, since the antenna coil for performing the proximity wireless communication with the antenna installed in the mobile device is disposed in the key cylinder device, the mobile device can be brought close to the key cylinder device by an action similar to the case where a mechanical key is inserted into a key hole, so that the locking and unlocking of the reclosable body can be performed without an uncomfortable feeling. In other words, even if it is not provided a measure affecting an external design such as explicitly indicating the position of the antenna coil outside the reclosable body, it is easy to make the user intuitive of the position where the mobile device has to be brought close to. Accordingly, it is possible to improve the convenience of the locking/unlocking system for locking/unlocking the reclosable body using the proximity wireless communication.

### DESCRIPTION OF THE DRAWINGS

FIG. 1 illustrates a configuration of a locking/unlocking system according to an embodiment.

FIG. 2 illustrates an appearance of a locking/unlocking device of FIG. 1.

FIG. 3 illustrates a configuration of a key cylinder device of FIG. 2.

FIG. 4 illustrates a functional configuration of the locking/unlocking system of FIG. 1.

### DESCRIPTION OF EMBODIMENTS

Exemplary embodiments will be described in detail below with reference to the accompanying drawings. In each of the drawings, the scale is appropriately changed in order to make each element illustrated have a recognizable size.

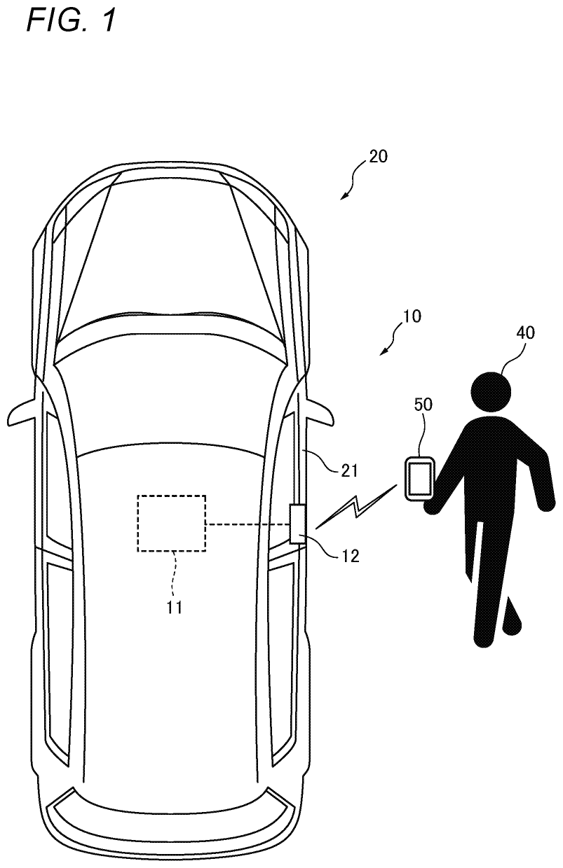

FIG. 1 illustrates a configuration of a locking/unlocking system 10 according to an embodiment. The locking/unlocking system 10 includes a control device 11 and a locking/unlocking device 12. The control device 11 and the locking/unlocking device 12 are installed in a vehicle 20. The locking/unlocking device 12 is a device for locking/unlocking a door 21 for opening/closing a cabin of the vehicle 20. The control device 11 is configured to control the operation of the locking/unlocking device 12. The vehicle 20 is an example of a mobile entity. The door 21 is an example of a reclosable body.

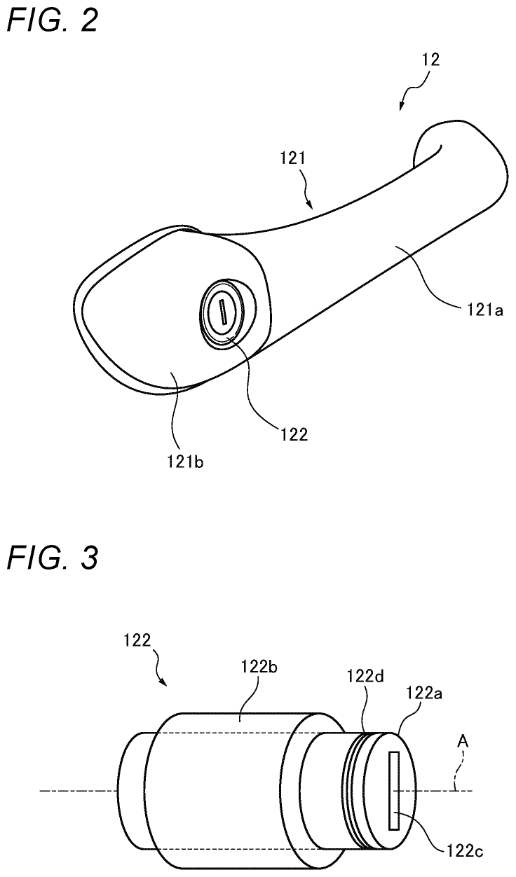

FIG. 2 illustrates an appearance of the locking/unlocking device 12. The locking/unlocking device 12 is attached to the door 21. The locking/unlocking device 12 includes a knob 121 and a key cylinder device 122. The knob 121 is configured to accept an operation performed by a user for opening and closing the door 21. The knob 121 is an example of an operated member. The key cylinder device 122 is configured to switch between a locked state and an unlocked state of the door 21.

FIG. 3 illustrates a configuration of the key cylinder device 122. The key cylinder device 122 includes a rotor 122a and a rotor case 122b. The rotor case 122b supports the rotor 122a so as to be rotatable about a rotation axis A. A key hole 122c is formed in the rotor 122a. A mechanical key (not illustrated) can be inserted into the key hole 122c. When a suitable mechanical key is inserted into the keyhole 122c, the rotor 122a is allowed to rotate about the rotation axis A. That is, the rotor 122a is configured to be capable of performing a rotary operation with a mechanical key.

The key cylinder device 122 includes an antenna coil 122d. The antenna coil 122d is disposed so as to form a loop with a conductive wire around the rotor 122a. In other words, the antenna coil 122d is disposed such that the rotation axis A of the rotor 122a extends in the loop thus formed.

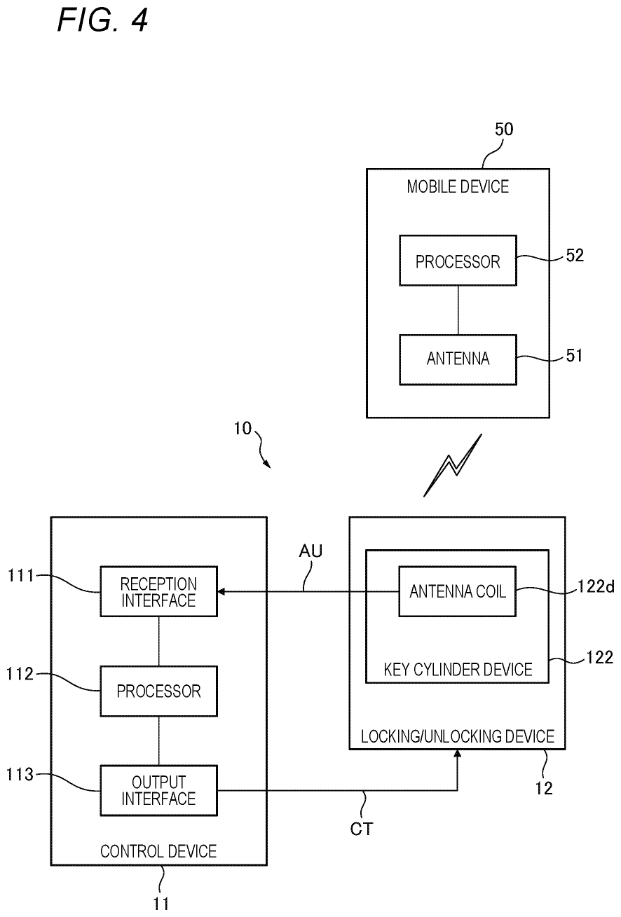

As illustrated in FIG. 1, the locking/unlocking system 10 is configured to be capable of locking/unlocking the door 21 by wireless communication using a mobile device 50 adapted to be carried by a user 40. As illustrated in FIG. 4, the mobile device 50 includes an antenna 51. The antenna 51 is configured to be capable of executing proximity wireless communication with the antenna coil 122d of the key cylinder device 122. The mobile device 50 may be provided as a portable medium such as a card that is not equipped with a power source, or may be provided as a general-purpose portable information terminal such as a smartphone.

As used herein, “proximity wireless communication” means contactless communication in which information is transmitted from a mobile device to a reader device through electromagnetic inductive coupling. Examples of the technology capable of executing the proximity wireless communication include NFC (Near Field Communication), RF-ID, and the like. As used herein, the term “proximity wireless communication” is distinguished from “short-range wireless communication” which is non-contact communication performed with radio waves while complying with IEEE 802.15 or IEEE 802.11 standards. Examples of the technology capable of executing the short-range wireless communication include Bluetooth (registered trademark), Bluetooth Low Energy (registered trademark), Ultra Wide Band (UWB), ZigBee (registered trademark), and Wi-Fi (registered trademark).

The control device 11 is configured to allow the locking/unlocking device 12 to lock the door 21 based on the proximity wireless communication performed between the antenna 51 installed in the mobile device 50 and the antenna coil 122d of the key cylinder device 122.

Specifically, an electromagnetic wave is generated from the antenna coil 122d based on power supplied from a power source (not illustrated). In response to an action of the user 40 bringing the antenna 51 of the mobile device 50 close to the antenna coil 122d, an induced electromotive force is generated in the antenna 51. The mobile device 50 includes a processor 52. The processor 52 is configured to read the authentication information AU from a storage (not illustrated) using the generated electromotive force, and transmit the authentication information AU from the antenna 51. The authentication information AU is information for authenticating at least one of the user 40 and the mobile device 50.

The processor 52 having such a function can be implemented by an exclusive integrated circuit in a case where the mobile device 50 is provided as a portable medium such as a card. A computer program for executing processing associated with the function is pre-installed in a memory element included in the integrated circuit. The authentication information AU may be stored in the memory element.

In a case where the mobile device 50 is provided as a general-purpose personal digital assistant, the processor 52 may be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the processing associated with the above-described function can be stored in the ROM. The authentication information AU may be stored in the general-purpose memory. The general-purpose microprocessor designates at least a part of the computer program stored in the ROM, loads the program on the RAM, and executes the processing described above in cooperation with the RAM.

The processor 52 may be implemented by an exclusive integrated circuit capable of executing the above-described computer program. Examples of the exclusive integrated circuit include a microcontroller, an ASIC, and an FPGA. In this case, the above-described computer program is pre-installed in a memory element included in the exclusive integrated circuit. The authentication information AU may be stored in the memory element. The processor 52 may also be implemented by a combination of a general-purpose microprocessor and an exclusive integrated circuit.

The control device 11 includes a reception interface 111. The reception interface 111 is configured as an interface capable of accepting the authentication information AU received by the antenna coil 122d.

The control device 11 includes a processor 112. The processor 112 is configured to collate the authentication information AU accepted by the reception interface 111 with the authentication information stored in a storage (not illustrated).

The control device 11 includes an output interface 113. The output interface 113 is configured as an interface for outputting a control signal CT for causing the locking/unlocking device 12 to perform the locking/unlocking of the door 21.

The processor 112 is configured to output a control signal CT from the output interface 113 in response to the confirmation that the authentication information AU accepted by the reception interface 111 matches the authentication information stored in the storage (not illustrated).

The processor 112 having the above-described function can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the processing associated with the above-described function can be stored in the ROM. The authentication information to be subjected to the collation may be stored in the general-purpose memory. The general-purpose microprocessor designates at least a part of the computer program stored in the ROM, loads the program on the RAM, and executes the processing described above in cooperation with the RAM.

The processor 112 may be implemented by an exclusive integrated circuit capable of executing the above-described computer program. Examples of the exclusive integrated circuit include a microcontroller, an ASIC, and an FPGA. In this case, the above-described computer program is pre-installed in a memory element included in the exclusive integrated circuit. The authentication information to be subjected to the collation may be stored in the memory element. The processor 112 may also be implemented by a combination of a general-purpose microprocessor and an exclusive integrated circuit.

According to the configuration as described above, in response to an action of the user 40 bringing an appropriate mobile device 50 close to the key cylinder device 122, the door 21 can be locked and unlocked without using a mechanical key. On the other hand, since the antenna coil 122d for performing the proximity wireless communication with the antenna 51 installed in the mobile device 50 is disposed in the key cylinder device 122, the mobile device 50 can be brought close to the key cylinder device 122 by an action similar to the case where a mechanical key is inserted into the key hole 122c, so that the locking and unlocking of the door 21 can be performed without an uncomfortable feeling. In other words, even if it is not provided a measure affecting an external design such as explicitly indicating the position of the antenna coil 122d outside the door 21, it is easy to make the user 40 intuitive of the position where the mobile device 50 has to be brought close to. Accordingly, it is possible to improve the convenience of the locking/unlocking system 10 for locking/unlocking the door 21 using the proximity wireless communication.

As illustrated in FIG. 3, the antenna coil 122d is formed by winding a conductive wire around an outer circumferential face of the rotor 122a. However, the antenna coil 122d may be disposed on the outer circumferential face of the rotor case 122b.

In either case, since it is easy to secure a large cross-sectional area of the coil as compared with a case where the antenna coil is disposed inside the knob 121, it is possible to increase the amount of magnetic flux reaching the antenna 51 installed in the mobile device 50. Accordingly, the stability of the proximity wireless communication is improved.

In either case, it is preferable to dispose the antenna coil 122d at a position closer to the entrance of the key hole 122c in the key cylinder device 122. As a result, it is possible to suppress a decrease in the strength of the magnetic field reaching the antenna 51 installed in the mobile device 50. Accordingly, the stability of the proximity wireless communication is improved.

In the key cylinder device 122, at least the rotor 122a is preferably formed of a material having a magnetic permeability. Examples of such materials include iron and nickel.

According to such a configuration, since the antenna coil 122d can be caused to serve as a choke coil, it is possible to suppress a decrease in the intensity of the magnetic field reaching the antenna 51 installed in the mobile device 50. Accordingly, the stability of the proximity wireless communication is improved.

In a case where the antenna 51 is a loop antenna, the higher the degree of matching between the loop shape of the antenna coil 122d and the loop shape of the antenna 51, the higher the efficiency of coupling between the antenna coil 122d and the antenna 51 by electromagnetic induction. As used herein, the term “degree of matching of the loop shape” means the degree of matching of not only the geometric shape of the loop, but also the size of the loop.

In a case where the antenna coil 122d is disposed around the rotor 122a of the key cylinder device 122 as in the present embodiment, the stability of the proximity wireless communication is improved because it is relatively easy to match the loop shape of the antenna coil 122d with the shape of the antenna 51.

As illustrated in FIG. 2, the knob 121 of the locking/unlocking device 12 includes a movable portion 121a and an immovable portion 121b. The movable portion 121a is a portion capable of being displaced in association with the opening and closing of the door 21. Specifically, the movable portion 121a is configured to be capable of performing an operation in which the user 40 grasps and pulls the movable portion 121a with a hand. When the operation is performed, the engagement between the door 21 and the vehicle body is released, so that the door 21 can be opened or closed. The immovable portion 121b is a portion whose position relative to the door 21 is unchanged. The key cylinder device 122 is disposed in the immovable portion 121b.

According to such a configuration, it is possible to suppress the stress applied to the movable portion 121a during the opening and closing of the door 21 from reaching to the antenna coil 122d. As a result, the stability of the magnetic field generated from the antenna coil 122d is improved, so that the stability of the proximity wireless communication is also improved.

The above embodiments are merely illustrative for facilitating understanding of the gist of the presently disclosed subject matter. The configuration according to each of the above embodiments can be appropriately modified or changed without departing from the gist of the presently disclosed subject matter.

The key cylinder device 122 is not necessarily disposed on the immovable portion 121b of the knob 121. For example, the key cylinder device 122 may be disposed on the movable portion 121a of the knob 121 or may be disposed on the door 21.

The mobile entity on which the control device 11 and the locking/unlocking device 12 are installed is not limited to the vehicle 20. Examples of another mobile entity include railways, aircraft, and ships. The mobile entity may not require a driver.

In addition, the reclosable body to be locked/unlocked by the locking/unlocking device 12 is not limited to the door 21 of the vehicle 20. Doors and windows in homes and facilities may also be an example of the reclosable body.

1. A locking/unlocking system configured to perform locking/unlocking of a reclosable body, comprising:
a key cylinder device provided with a rotor that is adapted to perform a rotary operation with a mechanical key;
an antenna coil disposed so as to form a loop around the rotor; and
a control device configured to allow the locking/unlocking of the reclosable body based on proximity wireless communication performed between the antenna coil and an antenna installed in a mobile device that is adapted to be carried by a user.

2. The locking/unlocking system according to claim 1,
wherein the antenna coil is disposed on an outer circumferential face of the rotor.

3. The locking/unlocking system according to claim 1,
wherein the antenna coil is disposed at a position where is closer to a key hole adapted to receive the mechanical key.

4. The locking/unlocking system according to claim 1,
wherein the rotor is formed of a material having magnetic permeability.

5. The locking/unlocking system according to claim 1,
wherein a shape of the loop corresponds to a shape of the antenna.

6. The locking/unlocking system according to claim 1,
wherein the reclosable body is installed in a vehicle.

7. A locking/unlocking device configured to perform locking/unlocking of a reclosable body, comprising:
an operated member adapted to accept an operation of a user who opens and closes the reclosable body; and
a key cylinder device configured to switch between a locked state and an unlocked state of the reclosable body,
wherein the key cylinder device includes:
a rotor adapted to perform a rotary operation with a mechanical key; and
an antenna coil disposed so as to form a loop around the rotor.

8. The locking/unlocking device according to claim 7,
wherein the operated member includes:
a movable portion adapted to be displaced in accordance with opening and closing of the reclosable body; and
an immovable portion a position relative to the reclosable body thereof is unchanged,
wherein the key cylinder device is disposed in the immovable portion.

9. A key cylinder device, comprising:
a rotor adapted to perform a rotary operation with a mechanical key; and
an antenna coil disposed so as to form a loop around the rotor.
